(19) United States
(12) Patent Application Publication
(10) Pub. No.: US 2020/0298603 A1
(43) Pub. Date: Sep. 24, 2020

(54) RIBBON TRANSPORT MECHANISM AND TAPE PRINTING APPARATUS

(71) Applicant: SEIKO EPSON CORPORATION, Tokyo (JP)

(72) Inventor: Shinsaku KOSUGE, Matsumoto-shi (JP)

(73) Assignee: SEIKO EPSON CORPORATION, Tokyo (JP)

(21) Appl. No.: 16/823,117

(22) Filed: Mar. 18, 2020

(30) Foreign Application Priority Data
Mar. 19, 2019 (JP) 2019-051757

(51) Int. Cl. B41J 33/14; B41J 2/325

(52) U.S. Cl. CPC B41J 33/14; B41J 2/325

(57) ABSTRACT

A ribbon transport mechanism includes a transport gear train that transmits rotational power from a transport motor to paying out and winding rotors. The transport gear train has paying-out-side and winding-side one-way clutches. When the transport motor rotates in a first direction, the paying-out-side one-way clutch suppresses the rotational power from being transmitted to the paying out rotor, whereas when the transport motor rotates in a second direction, the paying-out-side one-way clutch permits the rotational power to be transmitted to the paying out rotor. When the transport motor rotates in the first direction, the winding-side one-way clutch permits the rotational power to be transmitted to the winding rotor, whereas when the transport motor rotates in the second direction, the transport motor suppresses the rotational power from being transmitted to the winding rotor. The paying-out-side one-way clutch and the winding-side one-way clutch are provided coaxially.

The present application is based on, and claims priority from JP Application Serial Number 2019-051757, filed Mar. 19, 2019, the disclosure of which is hereby incorporated by reference herein in its entirety.

### BACKGROUND

### 1. Technical Field

This application relates to a ribbon transport mechanism that transports an ink ribbon and a tape printing apparatus equipped with the ribbon transport mechanism.

### 2. Related Art

JP-A-2013-159409 discloses a tape printing apparatus equipped with a ribbon transport mechanism that transports an ink ribbon. This ribbon transport mechanism includes a paying-out-side clutch mechanism and a winding-side clutch mechanism. The paying-out-side clutch mechanism selectively transmits the rotational power generated by a drive motor to a paying-out-side drive shaft, whereas the winding-side clutch mechanism selectively transmits the rotational power to a winding-side drive shaft.

In a known ribbon transport mechanism as described above, the paying-out-side clutch mechanism includes a paying-out-side sun gear and a paying-out-side planet gear; the paying-out-side planet gear engages with or is disengaged from a paying-out-side input gear while rotating and moving around the paying-out-side sun gear. Likewise, the winding-side clutch mechanism includes a winding-side sun gear and a winding-side planet gear; the winding-side planet gear engages with or is disengaged from a winding-side input gear while rotating and moving around the winding-side sun gear. Such ribbon transport mechanisms and tape printing apparatuses may disadvantageously have large bodies.

### SUMMARY

The disclosed embodiment is a ribbon transport mechanism provided in a tape printing apparatus. This ribbon transport mechanism includes a paying out rotor and a winding rotor. When a cartridge that includes a paying out core around which an ink ribbon is wound and a winding core that winds the ink ribbon paid out from the paying out core is attached to a cartridge mount section of the tape printing apparatus, the paying out rotor engages with the paying out core and the winding rotor engages with the winding core. The ribbon transport mechanism further includes: a transport motor that generates rotational power; and a transport gear train that receives the rotational power from the transport motor and transmits the received rotational power to both the paying out rotor and the winding rotor. The transport gear train includes a paying-out-side one-way clutch and a winding-side one-way clutch. When the transport motor rotates in a first direction, the paying-out-side one-way clutch suppresses the rotational power received from the transport motor from being transmitted to the paying out rotor, whereas when the transport motor rotates in a second direction, the paying-out-side one-way clutch permits the rotational power received from the transport motor to be transmitted to the paying out rotor; the second direction is opposite to the first direction. When the transport motor rotates in the first direction, the winding-side one-way clutch permits the rotational power received from the transport motor to be transmitted to the winding rotor, whereas when the transport motor rotates in the second direction, the winding-side one-way clutch suppresses the rotational power received from the transport motor from being transmitted to the winding rotor. The paying-out-side one-way clutch is coaxial with the winding-side one-way clutch.

The present disclosure is a tape printing apparatus to which a cartridge that includes a paying out core around which an ink ribbon is wound and a winding core that winds the ink ribbon paid out from the paying out core is to be attached. This tape printing apparatus includes: a cartridge mount section to which the cartridge is to be attached; a paying out rotor that, when the cartridge is attached to the cartridge mount section, engages with the paying out core; a winding rotor that, when the cartridge is attached to the cartridge mount section, engages with the winding core; a transport motor that generates rotational power; a transport gear train that receives the rotational power from the transport motor and transmits the received rotational power to both the paying out rotor and the winding rotor; and a printing head that performs a printing operation on a print tape. The transport gear train includes a paying-out-side one-way clutch and a winding-side one-way clutch. When the transport motor rotates in a first direction, the paying-out-side one-way clutch suppresses the rotational power received from the transport motor from being transmitted to the paying out rotor, whereas when the transport motor rotates in a second direction, the paying-out-side one-way clutch permits the rotational power received from the transport motor to be transmitted to the paying out rotor; the second direction is opposite to the first direction. When the transport motor rotates in the first direction, the winding-side one-way clutch permits the rotational power received from the transport motor to be transmitted to the winding rotor, whereas when the transport motor rotates in the second direction, the winding-side one-way clutch suppresses the rotational power received from the transport motor from being transmitted to the winding rotor. The paying-out-side one-way clutch is coaxial with the winding-side one-way clutch.

### BRIEF DESCRIPTION OF THE DRAWINGS

FIG. 1 illustrates a tape printing apparatus in which a tape cartridge is attached to a cartridge mount section, as viewed from an attachment direction.

FIG. 2 illustrates the tape printing apparatus in which a ribbon cartridge is attached to the cartridge mount section, as viewed from the attachment direction.

FIG. 3 illustrates the tape printing apparatus in which neither the tape cartridge nor the ribbon cartridge is attached to the cartridge mount section, as viewed from the attachment direction.

FIG. 4 illustrates, in perspective, the tape printing apparatus in which neither the tape cartridge nor the ribbon cartridge is attached to the cartridge mount section.

FIG. 5 illustrates the transport gear train in perspective.

FIG. 6 illustrates the transport gear train as viewed from the attachment direction; the directions in which the individual gears and rotors in the transport gear train rotate in conjunction with the rotation of the transport motor in a first direction are denoted by the arrows.

FIG. 7 illustrates the transport gear train as viewed from the attachment direction; the directions in which the individual gears and rotors in the transport gear train rotate in conjunction with the rotation of the transport motor in a second direction are denoted by the arrows.

FIG. 8 is an exploded, perspective view of the one-way clutch unit.

FIG. 9 is an exploded, perspective view of the one-way clutch unit from which the brake member is removed.

### DESCRIPTION OF EXEMPLARY EMBODIMENTS

With reference to the accompanying drawings, a description will be given below of a tape printing apparatus 1 according to some embodiments of the present disclosure. These drawings employ an X-Y-Z orthogonal coordinate system, but it should be noted that this coordinate system is used for the sake of the explanation and thus not intended to limit embodiments that will be described below. Furthermore, the number and numeric values of individual components are examples and thus not intended to limit the embodiments.

### Outline of Tape Printing Apparatus, Tape Cartridge, and Ribbon Cartridge

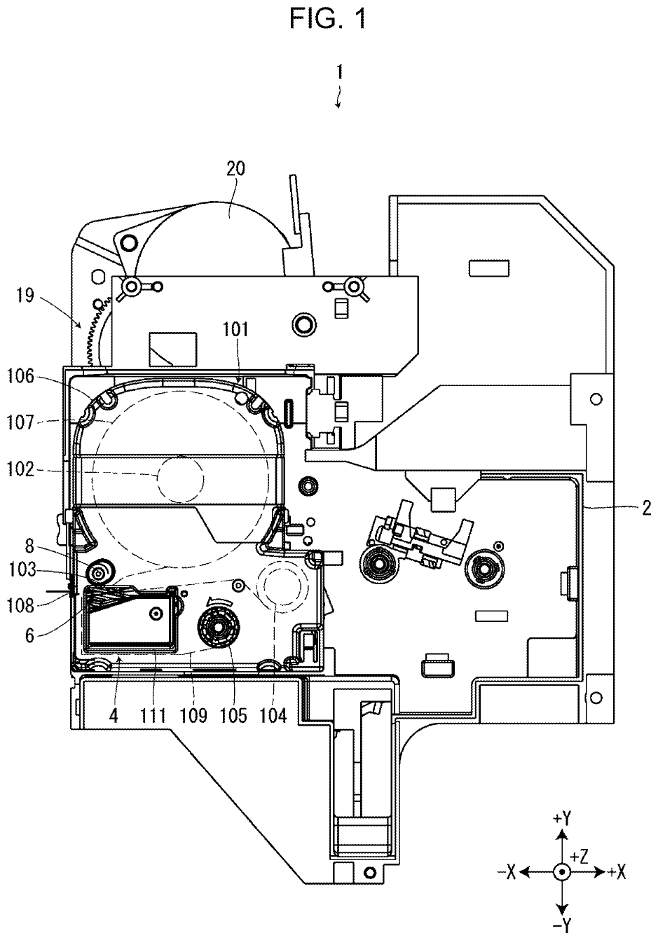

Referring to FIGS. 1 to 3, the tape printing apparatus 1 includes a cartridge mount section 2 to which a tape cartridge 101 and a ribbon cartridge 201 are to be selectively attached. In addition, the tape printing apparatus 1 further includes an unillustrated mount section cover that covers or exposes the cartridge mount section 2.

As illustrated in FIG. 1, the tape cartridge 101 includes a tape core 102, a first platen roller 103, a first paying out core 104, a first winding core 105, and a first cartridge case 106. Wound around the tape core 102 is a first print tape 107, which is to be paid out from the tape core 102 to the outside of the first cartridge case 106 via a tape outlet 108. The tape outlet 108 is disposed on the −X-side surface of the outer wall of the first cartridge case 106. Wound around the first paying out core 104 is a first ink ribbon 109, which is to be paid out from the first paying out core 104 to the first winding core 105 and wound around the first winding core 105. The first cartridge case 106, which forms the exterior of the tape cartridge 101, contains the tape core 102, the first platen roller 103, the first paying out core 104, the first winding core 105, the first print tape 107, and the first ink ribbon 109. The first cartridge case 106 has a first head insertion hole 111 that penetrates the first cartridge case 106 along the Z axis.

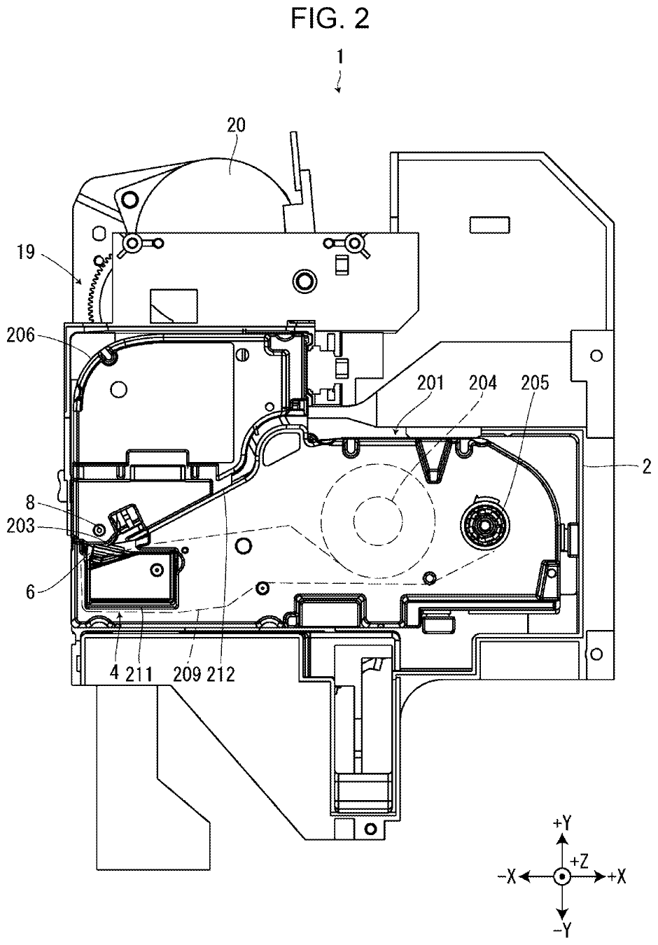

As illustrated in FIG. 2, the ribbon cartridge 201 includes a second platen roller 203, a second paying out core 204, a second winding core 205, and a second cartridge case 206. Wound around the second paying out core 204 is a second ink ribbon 209, which is to be paid out from the second paying out core 204 to the second winding core 205 and wound around the second winding core 205. The second cartridge case 206, which forms the exterior of the ribbon cartridge 201, contains the second platen roller 203, the second paying out core 204, the second winding core 205, and the second ink ribbon 209. The second cartridge case 206 has a second head insertion hole 211 that penetrates the second cartridge case 206. The second cartridge case 206 is provided with a second tape route 212. Furthermore, an unillustrated tape roller around which a second print tape is wound is disposed outside the tape printing apparatus 1 and introduces the second print tape to the second tape route 212.

The second print tape around the tape roller and the second ink ribbon 209 contained in the ribbon cartridge 201 may have any given initial lengths. In this embodiment, the second print tape may be greater in initial length than the first print tape 107 contained in the tape cartridge 101. Likewise, the second ink ribbon 209 may be greater in initial length than the first ink ribbon 109 contained in the tape cartridge 101. For example, if the tape printing apparatus 1 prints many labels at one time, the ribbon cartridge 201 is typically attached to the cartridge mount section 2.

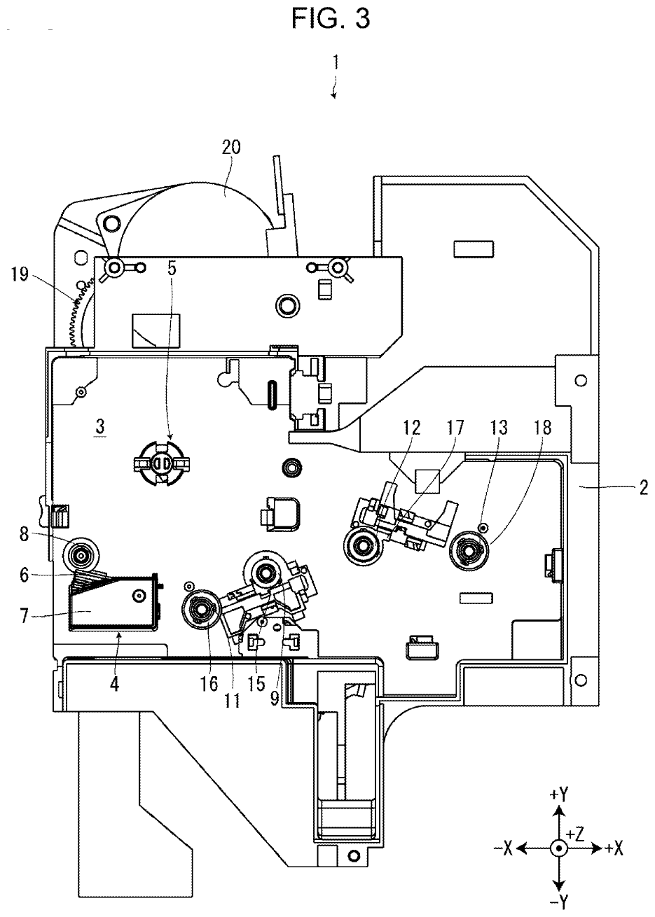

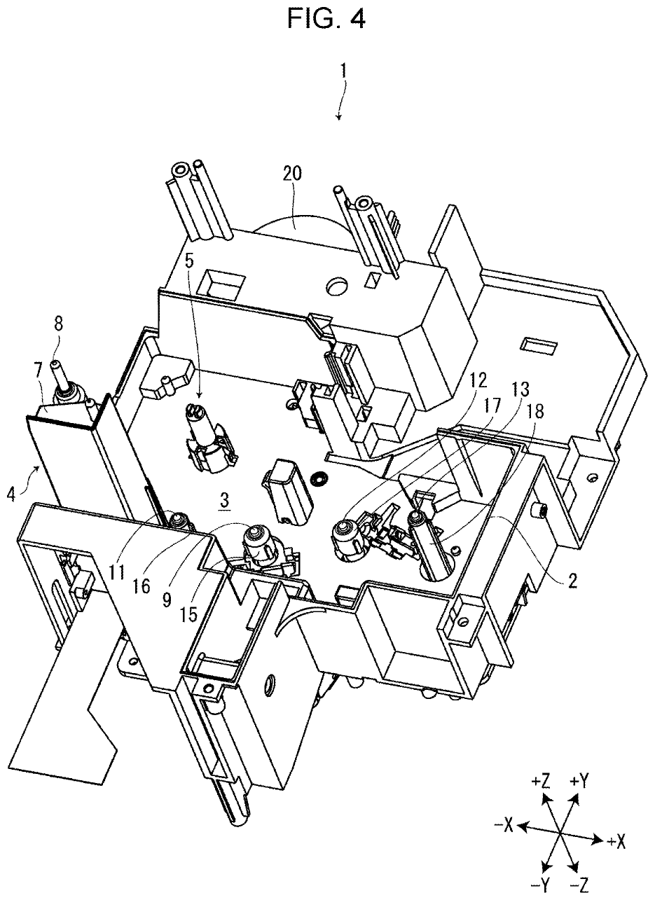

As illustrated in FIGS. 3 and 4, the cartridge mount section 2 has a recess that is open toward the +Z-side, and a head section 4 and a core projection 5 are disposed on a mount bottom surface 3 of this recess while protruding in the direction opposite to the attachment direction of the cartridge mount section 2. The head section 4 includes a printing head 6 and a head cover 7 that covers at least +X-, −Y-, and +Z-side surfaces of the printing head 6. In one embodiment, the printing head 6 may be a thermal head with a heater element. When the tape cartridge 101 is attached to the cartridge mount section 2, the head cover 7 is inserted into the first head insertion hole 111 and guides the attaching of the tape cartridge 101. Likewise, when the ribbon cartridge 201 is attached to the cartridge mount section 2, the head cover 7 is inserted into the second head insertion hole 211 and guides the attaching of the ribbon cartridge 201. In addition, when the tape cartridge 101 is attached to the cartridge mount section 2, the core projection 5 is accommodated in an unillustrated core recess provided in the tape cartridge 101.

Disposed on the mount bottom surface 3 are a platen shaft 8, a first winding shaft 11, a first paying out shaft 9, a second paying out shaft 12, and a second winding shaft 13 so as to be arranged in this order from the −X-side to the +X-side while protruding toward the +Z-side.

The platen shaft 8 is disposed close to the +Y-side surface of the printing head 6 while protruding in the direction opposite to the attachment direction. The protrusion of the platen shaft 8 is greater in amount than any of the first paying out shaft 9, the first winding shaft 11, the second paying out shaft 12, and the second winding shaft 13. When the tape cartridge 101 is attached to the cartridge mount section 2, the platen shaft 8 is inserted into the first platen roller 103 and guides the attaching of the tape cartridge 101 together with the head cover 7. Likewise, when the ribbon cartridge 201 is attached to the cartridge mount section 2, the platen shaft 8 is inserted into the second platen roller 203 and guides the attaching of the ribbon cartridge 201 together with the head cover 7. Hereinafter, the direction in which the tape cartridge 101 or the ribbon cartridge 201 is attached is referred to as the attachment direction. The attachment direction is parallel to the direction in which the platen shaft 8 protrudes or the Z axis. In this case, the attachment direction corresponds to the direction toward the −Z-side, whereas the direction opposite to the attachment direction corresponds to the direction toward the +Z-side.

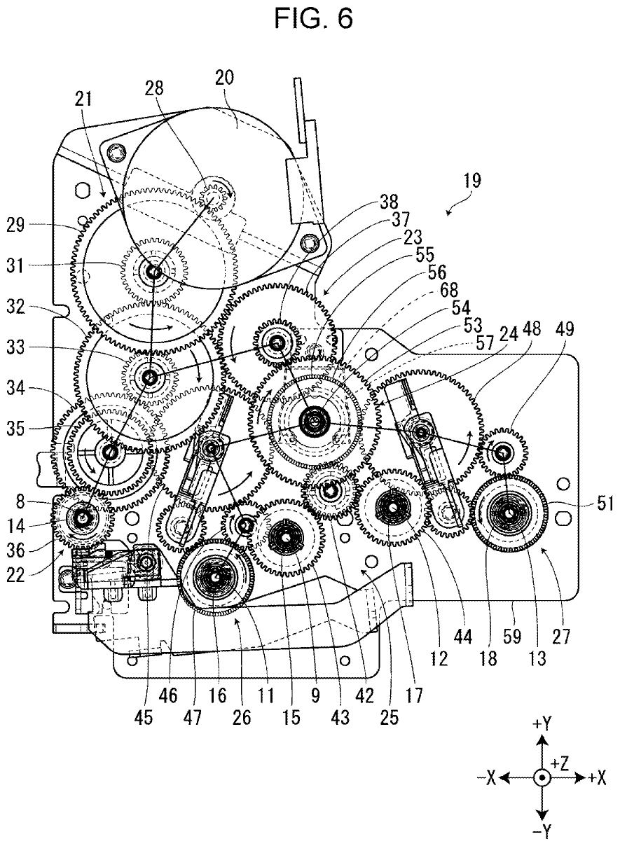

The platen shaft 8 rotatably supports a platen rotor 14 (see FIG. 6); the first paying out shaft 9 rotatably supports a first paying out rotor 15; the first winding shaft 11 rotatably supports a first winding rotor 16; the second paying out shaft 12 rotatably supports a second paying out rotor 17; and the second winding shaft 13 rotatably supports a second winding rotor 18. When the tape cartridge 101 is attached to the cartridge mount section 2, the platen rotor 14 is inserted into and engages with the first platen roller 103, the first paying out rotor 15 is inserted into and engages with the first paying out core 104, and the first winding rotor 16 is inserted into and engages with the first winding core 105. Likewise, when the ribbon cartridge 201 is attached to the cartridge mount section 2, the platen rotor 14 is inserted into and engages with the second platen roller 203, the second paying out rotor 17 is inserted into and engages with the second paying out core 204, and the second winding rotor 18 is inserted into and engages with the second winding core 205. Each of the platen rotor 14, the first paying out rotor 15, the first winding rotor 16, the second paying out rotor 17, and the second winding rotor 18 receives the rotational power from a transport motor 20 via a transport gear train 19. Herein, the mechanism constituted by at least the first paying out rotor 15, the first winding rotor 16, the second paying out rotor 17, the second winding rotor 18, the transport gear train 19, and the transport motor 20 corresponds to an example of a “ribbon transport mechanism”.

### Transport Gear Train

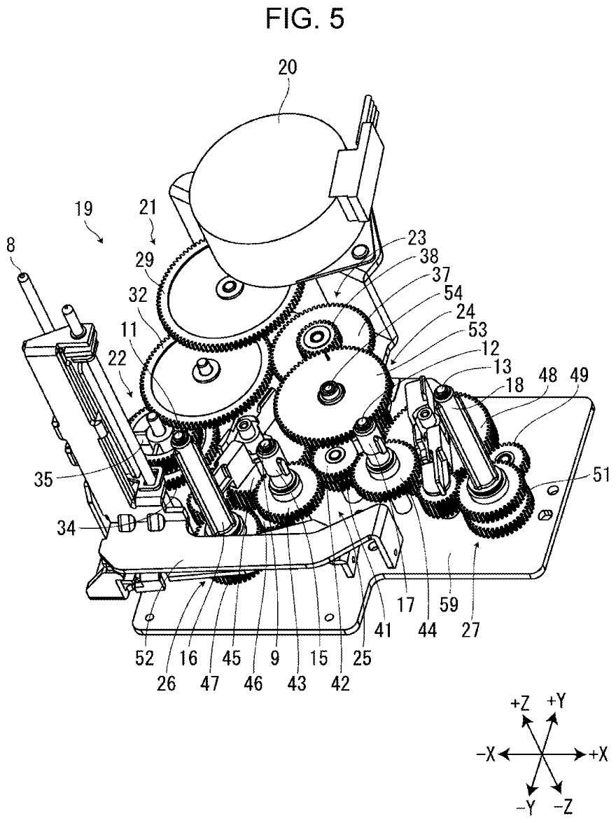

Referring to FIGS. 5 to 7, the tape printing apparatus 1 further includes a transport gear train 19. The transport gear train 19 includes a motor-side gear train 21, a platen-side gear train 22, a ribbon-side gear train 23, a one-way clutch unit 24, a paying-out-side gear train 25, a first winding-side gear train 26, and a second winding-side gear train 27.

The motor-side gear train 21 transmits the rotational power generated by the transport motor 20 to both the platen-side gear train 22 and the ribbon-side gear train 23. The motor-side gear train 21 includes: a first motor-side gear 28 disposed on the output shaft of the transport motor 20; a second motor-side gear 29 that engages with the first motor-side gear 28; and a third motor-side gear 31 fixed to the back surface of the second motor-side gear 29 as viewed from the attachment direction. The motor-side gear train 21 further includes: a fourth motor-side gear 32 that engages with the third motor-side gear 31; and a fifth motor-side gear 33 fixed to the back surface of the fourth motor-side gear 32 as viewed from the attachment direction.

When receiving the rotational power from the transport motor 20 via the motor-side gear train 21, the platen-side gear train 22 transmits the received rotational power to the platen rotor 14. The platen-side gear train 22 includes: a first platen-side gear 34 that engages with the fifth motor-side gear 33; a second platen-side gear 35 fixed to the front surface of the first platen-side gear 34 as viewed from the attachment direction; and a third platen-side gear 36 that engages with the second platen-side gear 35. The third platen-side gear 36 is rotatably disposed on the platen shaft 8. The platen rotor 14 is fixed to the front surface of the third platen-side gear 36 as viewed from the attachment direction.

When receiving the rotational power from the transport motor 20 via the motor-side gear train 21, the ribbon-side gear train 23 transmits the received rotational power to the one-way clutch unit 24. The ribbon-side gear train 23 includes: a first ribbon-side gear 37 that engages with the fourth motor-side gear 32; and a second ribbon-side gear 38 fixed to the front surface of the first ribbon-side gear 37 as viewed from the attachment direction.

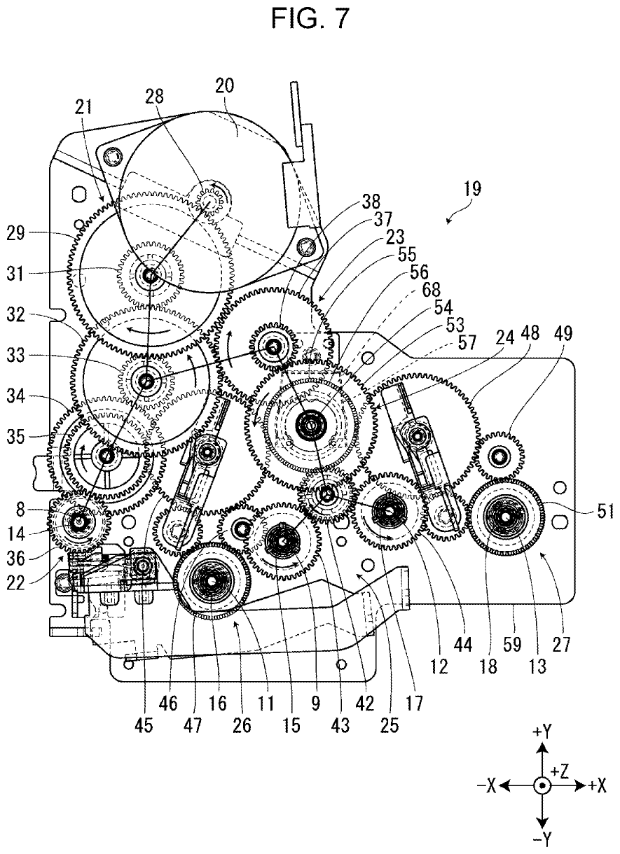

When receiving the rotational power from the transport motor 20 via the second ribbon-side gear 38, the one-way clutch unit 24 selectively transmits the received rotational power to one or more of the paying-out-side gear train 25, the first winding-side gear train 26, and the second winding-side gear train 27, depending on in which direction the transport motor 20 rotates. More specifically, when the transport motor 20 rotates in a first direction, namely, in a clockwise direction as illustrated in FIG. 6, the one-way clutch unit 24 receives the rotational power from the transport motor 20 and transmits the received rotational power to both the first winding-side gear train 26 and the second winding-side gear train 27. When the transport motor 20 rotates in a second direction, which is opposite to the first direction, namely, in a counterclockwise direction as illustrated in FIG. 7, the one-way clutch unit 24 receives the rotational power from the transport motor 20 and transmits the received rotational power to the paying-out-side gear train 25. Herein, the clockwise and counterclockwise directions correspond to those as viewed from the attachment direction. Details of the configuration of the one-way clutch unit 24 will be described later.

When receiving the rotational power from the transport motor 20 via the one-way clutch unit 24, the paying-out-side gear train 25 transmits the received rotational power to both the first paying out rotor 15 and the second paying out rotor 17. The paying-out-side gear train 25 includes a first paying-out-side gear 41 and a second paying-out-side gear 42; the first paying-out-side gear 41 engages with the paying-out-side one-way clutch 55 that will be described later, and the second paying-out-side gear 42 is disposed in front of the first paying-out-side gear 41 as viewed from the attachment direction and engages with the first-paying-outside gear 41. The paying-out-side gear train 25 further includes a third paying-out-side gear 43 and a fourth paying-out-side gear 44; the third paying-out-side gear 43 is positioned on the −X-side of the second paying-out-side gear 42 and engages with the second paying-out-side gear 42, and the fourth paying-out-side gear 44 is positioned on the +X-side of the second paying-out-side gear 42 and engages with the second paying-out-side gear 42. The third paying-out-side gear 43 is coupled to the first paying out rotor 15 so as to be rotatable around the first paying out shaft 9. The fourth paying-out-side gear 44 is coupled to the second paying out rotor 17 so as to be rotatable around the second paying out shaft 12.

When receiving the rotational power from the transport motor 20 via the one-way clutch unit 24, the first winding-side gear train 26 transmits the received rotational power to the first winding rotor 16. The first winding-side gear train 26 includes a first first-winding-side gear 45, a second first-winding-side gear 46, and a third first-winding-side gear 47. The first first-winding-side gear 45 engages with a winding-side one-way clutch 56 that will be described later; the second first-winding-side gear 46 engages with the first first-winding-side gear 45; and the third first-winding-side gear 47 engages with the second first-winding-side gear 46. The third first-winding-side gear 47 is rotatably disposed on the first winding shaft 11 and is coupled to the first winding rotor 16.

When receiving the rotational power from the transport motor 20 via the one-way clutch unit 24, the second winding-side gear train 27 transmits the received rotational power to the second winding rotor 18. The second winding-side gear train 27 includes a first second-winding-side gear 48, a second second-winding-side gear 49, and a third second-winding-side gear 51. The first second-winding-side gear 48 engages with the winding-side one-way clutch 56 that will be described later; the second second-winding-side gear 49 engages with the first second-winding-side gear 48; and the third second-winding-side gear 51 engages with the second second-winding-side gear 49. The third second-winding-side gear 51 is rotatably disposed on the second winding shaft 13 and is coupled to the second winding rotor 18.

When the transport motor 20 rotates in the first direction as illustrated in FIG. 6, the individual gears constituting the transport gear train 19 rotate in respective directions, which are referred to as first directions of the individual gears. When the transport motor 20 rotates in the second direction as illustrated in FIG. 7, the individual gears constituting the transport gear train 19 rotate in respective opposite directions, which are referred to as second directions of the individual gears. For example, the first direction of a drive gear 53, described later, in the one-way clutch unit 24 corresponds to a clockwise direction, whereas the second direction of the drive gear 53 corresponds to a counterclockwise direction.

Printing Process Performed with Tape Cartridge Attached

When the tape cartridge 101 is attached to the cartridge mount section 2 of the tape printing apparatus 1 as illustrated in FIG. 1, the first platen roller 103 in the tape cartridge 101 engages with the platen rotor 14 in the cartridge mount section 2, the first paying out core 104 in the tape cartridge 101 engages with the first paying out rotor 15 in the cartridge mount section 2, and the first winding core 105 in the tape cartridge 101 engages with the first winding rotor 16 in the cartridge mount section 2. As a result, the transport motor 20 can transmit its rotational power to the first platen roller 103, the first paying out core 104, and the first winding core 105.

In addition to the above, the head section 4 in the cartridge mount section 2 is inserted into the first head insertion hole 111 in the tape cartridge 101. Then, the mount section cover is attached to the cartridge mount section 2, after which a head moving mechanism 52 (see FIG. 5) moves the printing head 6 to the platen shaft 8, thereby nipping both the first print tape 107 and the first ink ribbon 109 between the printing head 6 and the first platen roller 103.

Following the above, when the transport motor 20 rotates in the first direction, the rotational power generated by the transport motor 20 is transmitted to both the platen rotor 14 and the first winding rotor 16 via the transport gear train 19. As a result, the first platen roller 103 rotates in a feeding direction, and the first winding core 105 rotates in a winding direction. Herein, the expression “the first platen roller 103 rotates in a feeding direction” means that the first platen roller 103 rotates in such a way that the first print tape 107 is paid out to the tape outlet 108 and that the first ink ribbon 109 is paid out from the first paying out core 104 to the first winding core 105. The expression “the first winding core 105 rotates in a winding direction” means that the first winding core 105 rotates in such a way that the first ink ribbon 109 paid out from the first paying out core 104 is wound around the first winding core 105.

When the transport motor 20 rotates in the second direction, the rotational power generated by the transport motor 20 is transmitted to both the platen rotor 14 and the first paying out rotor 15 via the transport gear train 19. As a result, the first platen roller 103 rotates in a reverse direction, and the first paying out core 104 rotates in a rewinding direction. Herein, the expression “the first platen roller 103 rotates in a reverse direction” means that the first print tape 107 is fed back from the tape outlet 108 to the first print tape 107 and that the first ink ribbon 109 is fed back from the first winding core 105 to the first paying out core 104. The expression “the first paying out core 104 rotates in a rewinding direction” means that the first ink ribbon 109 paid out from the first paying out core 104 is rewound around the first paying out core 104.

The tape printing apparatus 1 rotates the transport motor 20 in the first direction and heats the printing head 6. Then, the tape printing apparatus 1 prints information that has been received via an input device, such as a keyboard, on a predetermined portion of the first print tape 107 while feeding both the first print tape 107 and the first ink ribbon 109. After having printed the information, the tape printing apparatus 1 uses an unillustrated cutter disposed between the cartridge mount section 2 and a tape ejection hole to cut the portion off the first print tape 107. Then, the tape printing apparatus 1 rotates the transport motor 20 in the second direction, thereby feeding back the first print tape 107 until its end is positioned close to a predetermined site between the printing head 6 and the first platen roller 103. In this way, the tape printing apparatus 1 successfully minimizes a margin of the first print tape 107 at its forward end which is to be used for the next printing.

The tape printing apparatus 1 also performs the printing operation in the same manner when the ribbon cartridge 201 is attached to the cartridge mount section 2. In short, the tape printing apparatus 1 prints information on the second print tape while feeding both the second print tape and the second ink ribbon 209 between the printing head 6 and the second platen roller 203.

### One-Way Clutch Unit

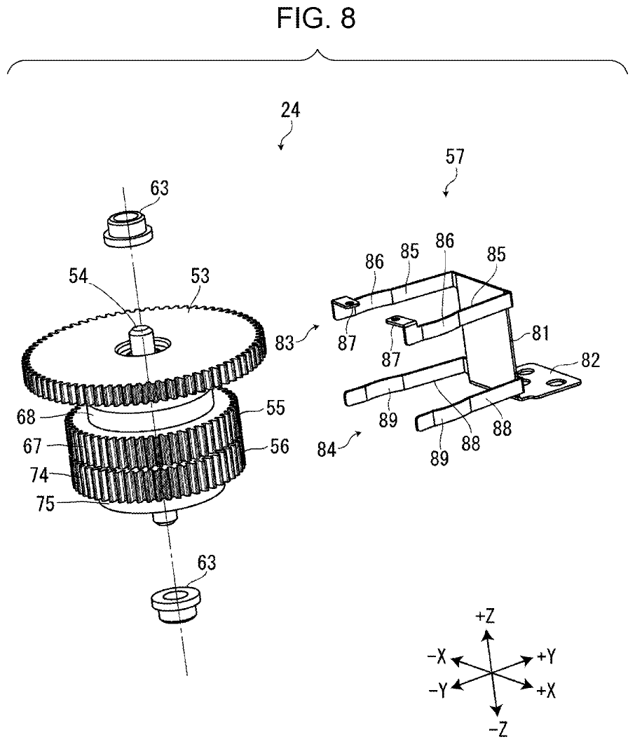

As illustrated in FIG. 8, the one-way clutch unit 24 includes the drive gear 53, a clutch shaft 54, the paying-out-side one-way clutch 55, the winding-side one-way clutch 56, and a brake member 57.

The drive gear 53 engages with the second ribbon-side gear 38 (see FIG. 6). Thus, via the second ribbon-side gear 38, the drive gear 53 receives the rotational power from the transport motor 20.

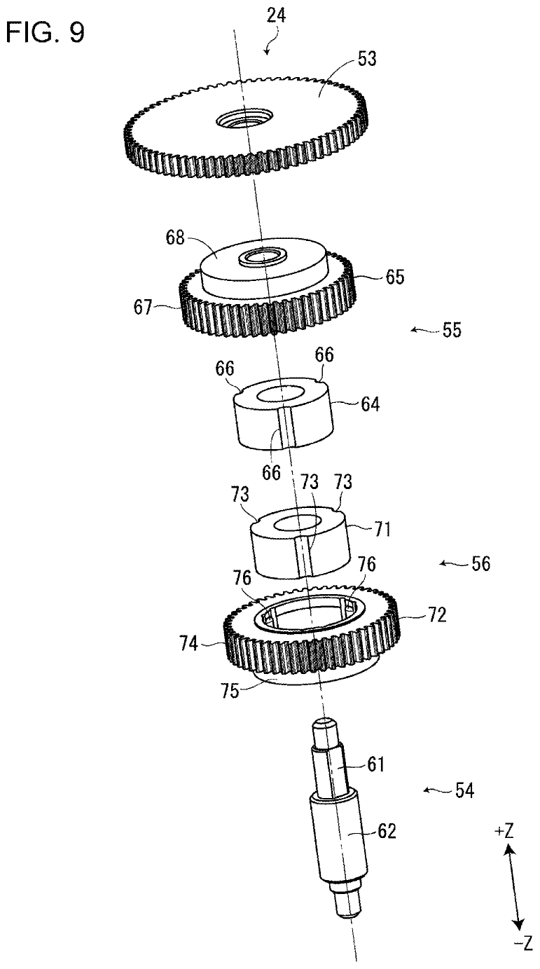

The clutch shaft 54 rotates together with the drive gear 53, thereby transmitting the rotational power from the drive gear 53 to both the paying-out-side one-way clutch 55 and the winding-side one-way clutch 56. The clutch shaft 54 is rotatably supported on a device frame 59 (see FIG. 6) while protruding from a device frame 59 in the direction opposite to the attachment direction. As illustrated in FIG. 9, the clutch shaft 54 includes a gear fitting section 61 and a one-way-clutch fitting section 62; the gear fitting section 61 is disposed in front of the one-way-clutch fitting section 62 as viewed from the attachment direction. The gear fitting section 61, which is processed such that its cross section becomes similar to the shape of the letter “D”, is fitted into the drive gear 53. The one-way-clutch fitting section 62, which has a circular cross section, is fitted into the winding-side one-way clutch 56 and the paying-out-side one-way clutch 55 in this order. The paying-out-side one-way clutch 55 is coaxial with the winding-side one-way clutch 56. The clutch shaft 54 has bearings 63 at both the ends.

The paying-out-side one-way clutch 55 includes a paying-out-side inner ring member 64 and a paying-out-side outer ring member 65; the paying-out-side outer ring member 65 is disposed on the outer circumference of the paying-out-side inner ring member 64. The clutch shaft 54 is fitted into the paying-out-side inner ring member 64 so that the paying-out-side inner ring member 64 rotates together with the clutch shaft 54. The paying-out-side inner ring member 64 has, on its outer circumference, three paying-out-side inner ring engaging sections 66 arranged at substantially equal intervals. The paying-out-side outer ring member 65 includes a paying-out-side outer ring gear 67 and a paying-out-side outer ring projection 68. The paying-out-side outer ring gear 67 is disposed on the outer circumference of the paying-out-side outer ring member 65 and engages with the first paying-out-side gear 41. The paying-out-side outer ring gear 67 has, on its inner circumference, three unillustrated paying-out-side outer engaging sections arranged at substantially equal intervals. The paying-out-side outer ring projection 68 protrudes in a substantially cylindrical shape and in the direction opposite to the attachment direction from the front surface of the paying-out-side outer ring gear 67 as viewed from the attachment direction.

When both the drive gear 53 and the paying-out-side inner ring member 64 rotate in the first direction, the paying-out-side inner ring engaging sections 66 are disengaged from the paying-out-side outer engaging sections. In this case, the torque of the paying-out-side inner ring member 64 is suppressed from being transmitted to the paying-out-side outer ring member 65. As a result, the paying-out-side outer ring member 65 does not rotate, and the paying-out-side inner ring member 64 thus rotates at idle. When both the drive gear 53 and the paying-out-side inner ring member 64 rotate in the second direction, the paying-out-side inner ring engaging sections 66 engages with the paying-out-side outer engaging sections. In this case, the torque of the paying-out-side inner ring member 64 is permitted to be transmitted to the paying-out-side outer ring member 65. As a result, the paying-out-side outer ring member 65 rotates in the second direction. In short, when the transport motor 20 rotates in the first direction as illustrated in FIG. 6, the paying-out-side one-way clutch 55 receives the rotational power from transport motor 20 via the drive gear 53 and suppresses the received rotational power from being transmitted to the paying-out-side gear train 25. When the transport motor 20 rotates in the second direction as illustrated in FIG. 7, the paying-out-side one-way clutch 55 receives the rotational power from transport motor 20 via the drive gear 53 and permits the received rotational power to be transmitted to the paying-out-side gear train 25.

The winding-side one-way clutch 56 includes a winding-side inner ring member 71 and a winding-side outer ring member 72; the winding-side outer ring member 72 is disposed on the outer circumference of the winding-side inner ring member 71. The clutch shaft 54 is fitted into the winding-side inner ring member 71 so that the winding-side inner ring member 71 rotates together with the clutch shaft 54. The winding-side inner ring member 71 has, on its outer circumference, three winding-side inner ring engaging sections 73 arranged at substantially equal intervals. The winding-side outer ring member 72 includes a winding-side outer ring gear 74 and a winding-side outer ring projection 75. The winding-side outer ring gear 74 is disposed on the outer circumference of the winding-side outer ring member 72 and engages with both the first first-winding-side gear 45 and the first second-winding-side gear 48. The winding-side outer ring gear 74 has, on its inner circumference, three winding-side outer ring engaging sections 76 arranged at substantially equal intervals. The winding-side outer ring projection 75 protrudes in a substantially cylindrical shape and in the attachment direction from the back surface of the winding-side outer ring gear 74 as viewed from the attachment direction.

When both the drive gear 53 and the winding-side inner ring member 71 rotate in the first direction, the winding-side inner ring engaging sections 73 engage with the winding-side outer ring engaging sections 76. In this case, the torque of the winding-side inner ring member 71 is permitted to be transmitted to the winding-side outer ring member 72. As a result, the winding-side outer ring member 72 rotates in the first direction. When both the drive gear 53 and the winding-side inner ring member 71 rotate in the second direction, the winding-side inner ring engaging section 73 is disengaged from the winding-side outer ring engaging sections 76. In this case, the torque of the winding-side inner ring member 71 is suppressed from being transmitted to the winding-side outer ring member 72. As a result, the winding-side outer ring member 72 does not rotate, but the winding-side inner ring member 71 rotates at idle. In short, when the transport motor 20 rotates in the first direction as illustrated in FIG. 6, the winding-side one-way clutch 56 receives the rotational power from transport motor 20 via the drive gear 53 and permits the received rotational power to be transmitted to both the first winding-side gear train 26 and the second winding-side gear train 27. When the transport motor 20 rotates in the second direction as illustrated in FIG. 7, the winding-side one-way clutch 56 receives the rotational power from transport motor 20 via the drive gear 53 and suppresses the received rotational power from being transmitted to both the first winding-side gear train 26 and the second winding-side gear train 27.

The paying-out-side one-way clutch 55 and the winding-side one-way clutch 56 may be identical types of one-way clutches. In addition, both of the paying-out-side one-way clutch 55 and the winding-side one-way clutch 56 are disposed on the clutch shaft 54 in mutually opposite orientations, so that the drive gear 53 rotates in opposite directions when the torque is transmitted to the paying-out-side one-way clutch 55 and when the torque is transmitted to the winding-side one-way clutch 56. By using identical types of one-way clutches for the paying-out-side one-way clutch 55 and the winding-side one-way clutch 56, the number of different types of components can be decreased. Herein, identical types of one-way clutches refer to those that have the same product number and be produced by the same manufacturer. However, the paying-out-side one-way clutch 55 and the winding-side one-way clutch 56 do not necessarily have to be identical types of one-way clutches.

The brake member 57 is configured to stop the rotations of the paying-out-side outer ring member 65 and the winding-side outer ring member 72 which are caused by the idle torque. As described above, when the transport motor 20 and the paying-out-side inner ring member 64 in the paying-out-side one-way clutch 55 rotate in the first direction, the paying-out-side inner ring member 64 suppresses the torque from being transmitted to the paying-out-side outer ring member 65, so that the paying-out-side outer ring member 65 does not rotate and the paying-out-side inner ring member 64 thus rotates at idle. In this case, however, if no load is placed on the paying-out-side outer ring member 65, the idle torque of the paying-out-side one-way clutch 55 may be transmitted to the paying-out-side outer ring member 65 through the sliding friction generated between the paying-out-side inner ring member 64 and the paying-out-side outer ring member 65. This idle torque acts on the paying-out-side outer ring member 65 so as to rotate in the first direction. As a result, if the transport motor 20 rotates in the first direction, a backlash may be generated in the first paying-out-side gear 41 at the front end of the paying-out-side one-way clutch 55 in the second direction.

If the backlash is generated in the above manner, when the transport motor 20 switches its rotational direction from the first direction to the second direction, both the first paying out rotor 15 and the second paying out rotor 17 may start rotating after the first platen roller 103 or the second platen roller 203 has rotated. In this case, while being fed back to the first paying out core 104, the first ink ribbon 109 may become loose and fail to be properly wound around the first paying out core 104, or while being fad back to the second paying out core 204, the second ink ribbon 209 may become loose and fail to be properly wound around the second paying out core 204. In this embodiment, the brake member 57 is therefore provided to stop the paying out-side outer ring member 65 from rotating in the first direction due to the idle torque of the paying-out-side one-way clutch 55, thereby reducing the generation of the backlash in the first paying-out-side gear 41 at the front end of the paying-out-side one-way clutch 55 in the second direction.

Likewise the above, if a backlash is generated in both the first first-winding-side gear 45 and the first second-winding-side gear 48 at the front end of the winding-side one-way clutch 56 in the first direction due to the idle torque of the winding-side one-way clutch 56, when the transport motor 20 switches its rotational direction from the second direction to the first direction, the first winding rotor 16 and the second winding rotor 18 may start rotating after the first platen roller 103 or the second platen roller 203 has rotated. In this embodiment, the brake member 57 is therefore provided to stop the winding-side outer ring member 72 from rotating in the second direction due to the idle torque of the winding-side one-way clutch 56, thereby reducing the generation of the backlash in both the first first-winding-side gear 45 and the first second-winding-side gear 48 at the front end of the winding-side one-way clutch 56 in the first direction.

As illustrated in FIG. 8, the brake member 57 includes a coupling section 81, a fixed section 82, a paying-out-side brake section 83, and a winding-side brake section 84. The coupling section 81, the fixed section 82, the paying-out-side brake section 83, and the winding-side brake section 84 may be integrally formed by bending a single elastic plate, for example, made of metal.

The coupling section 81, which is elongated in the attachment direction, joins the paying-out-side brake section 83 to the winding-side brake section 84. The fixed section 82 protrudes from the front end of the coupling section 81 in the attachment direction toward the +Y-side and is fixed to the device frame 59.

The paying-out-side brake section 83 stops the paying-out-side outer ring member 65 from rotating due to the idle torque of the paying-out-side one-way clutch 55. The paying-out-side brake section 83 has two paying-out-side pinching sections 85 that protrude in the −Y direction from +X and −X sides of the coupling section 81. Provided near the ends of the paying-out-side pinching sections 85 are paying-out-side sliding sections 86 each of which has an arc shape.

The paying-out-side pinching sections 85 pinch the circumference of the paying-out-side outer ring projection 68 by using the paying-out-side sliding sections 86 (see FIG. 6). When the paying-out-side outer ring member 65 rotates, a sliding friction is generated between each paying-out-side sliding section 86 and the outer circumference of the paying-out-side outer ring projection 68 to place a sliding load on the paying-out-side outer ring member 65. This sliding load is effective in stopping the paying-out-side outer ring member 65 from rotating in the first direction due to the idle torque generated when the paying-out-side inner ring member 64 rotates in the first direction, thereby successively reducing generation of a backlash in the first paying-out-side gear 41 at the front end of the paying-out-side one-way clutch 55 in the second direction. The sliding torque may be set to be sufficiently lower than the torque that the paying-out-side inner ring member 64 transmits to the paying-out-side outer ring member 65 when the paying-out-side inner ring member 64 rotates in the second direction. Setting the sliding torque in this manner sufficiently reduces the sliding load that the paying-out-side pinching sections 85 place on the paying-out-side outer ring member 65 when the paying-out-side inner ring member 64 rotates in the second direction, thereby successfully facilitating the rotation of the paying-out-side inner ring member 64.

The ends of the paying-out-side pinching sections 85 are provided with respective paying-out-side pushing sections 87 each of which protrudes from a corresponding one of the paying-out-side pinching sections 85 toward the other. The paying-out-side pushing sections 87 make contact with the front surface of the paying-out-side outer ring projection 68 as viewed from the attachment direction and press the paying-out-side outer ring member 65 so as not to displace in the attachment direction during the rotation. Providing the paying-out-side pushing sections 87 in this manner successfully reduces the risk of the base portions of the paying-out-side pinching sections 85 making contact with the paying-out-side outer ring gear 67 to disturb the rotation of the paying-out-side outer ring member 65.

The winding-side brake section 84 of the brake member 57 is configured to stop the winding-side outer ring member 72 from rotating due to an idle torque of the winding-side one-way clutch 56. The winding-side brake section 84 may have substantially the same configuration as the paying-out-side brake section 83. More specifically, the winding-side brake section 84 is provided with two winding-side pinching sections 88 that protrude from the front ends of the coupling section 81 in the attachment direction toward the −Y-side. Provided near the ends of the winding-side pinching sections 88 are respective winding-side sliding sections 89. When the winding-side inner ring member 71 rotates in the second direction, the winding-side pinching sections 88 place a sliding load on the winding-side outer ring member 72, thereby stopping the winding-side outer ring member 72 from rotating in the second direction due to the idle torque. This sliding load is effective in reducing generation of a backlash in both the first first-winding-side gear 45 and the first second-winding-side gear 48 at the front end of the winding-side one-way clutch 56 in the first direction. It should be noted that the ends of the winding-side pinching sections 88 are not provided with winding-side pressers, which are equivalent to the paying-out-side pushing sections 87 at the ends of the paying-out-side pinching sections 85. One reason is that, instead of such winding-side pressers, the device frame 59 makes contact with the back side of the winding-side outer ring projection 75 as viewed from the attachment direction and reduces displacement of the winding-side outer ring member 72 in the attachment direction during the rotation. Obviously, winding-side pressers may be provided in the winding-side pinching sections 88.

### The Number of Engagement Points

With reference to FIGS. 6 and 7, a description will be given below of the number of points at which gears in the transport gear train 19 engage with one another. As described above, when the transport motor 20 rotates in the first direction, the brake member 57 reduces generation of a backlash in the first paying-out-side gear 41 at the front end of the paying-out-side one-way clutch 55 in the second direction. This configuration, when the transport motor 20 rotates in the first direction, reduces generation of backlashes in the output-side gears of the engaging gears at the front ends of the input-side gears in the second direction between the paying-out-side one-way clutch 55 and the first paying out rotor 15 or between the paying-out-side one-way clutch 55 and the second paying out rotor 17. When the transport motor 20 rotates in the second direction, the brake member 57 reduces generation of a backlash in both the first first-winding-side gear 45 and the first second-winding-side gear 48 at the front end of the winding-side one-way clutch 56 in the first direction. This configuration, when the transport motor 20 rotates in the second direction, reduces generation of backlashes in the output-side gears of the engaging gears at the front ends of the input-side gears in the first direction between the winding-side one-way clutch 56 and the first winding rotor 16 or between the winding-side one-way clutch 56 and the second winding rotor 18.

On the other hand, when the transport motor 20 rotates in the first direction, backlashes are also generated in the output-side gears of the engaging gears at the front ends of the input-side gears in the second direction between the transport motor 20 and the one-way clutch unit 24. When the transport motor 20 rotates in the second direction, backlashes are also generated in the output-side gears at the front ends of the input-side gears in the first direction therebetween.

Likewise the above, when the transport motor 20 rotates in the first direction, backlashes are generated in the output-side gears of the engaging gears at the front ends of the input-side gears in the second direction between the transport motor 20 and the platen rotor 14. When the transport motor 20 rotates in the second direction, backlashes are also generated in the output-side gears at the front ends of the input-side gears in the first direction therebetween.

When the transport motor 20 switches its rotational direction from the first direction to the second direction, backlashes generated in the output-side gears at the front ends of the input-side gears in the second direction are maintained for a period proportional to the number of points at which the gears engage with one another. For example, if the number of points at which the gears engage with one another between the transport motor 20 and the one-way clutch unit 24 is larger than that between the transport motor 20 and the platen rotor 14, when the transport motor 20 switches its rotational direction from the first direction to the second direction, both the first paying out rotor 15 and the second paying out rotor 17 may start rotating after the platen rotor 14 has started rotating. In this case, while being fed back to the first paying out core 104, the first ink ribbon 109 may become loose and fail to be properly wound around the first paying out core 104, or while being fad back to the second paying out core 204, the second ink ribbon 209 may become loose and fail to be properly wound around the second paying out core 204.

Likewise the above, when the transport motor 20 switches its rotational direction from the second direction to the first direction, backlashes generated in the output-side gears at the front ends of the input-side gears in the second direction are maintained for a period proportional to the number of points at which the gears engage with one another. For example, if the number of engagement points of the gears between the transport motor 20 and the one-way clutch unit 24 is larger than that between the transport motor 20 and the platen rotor 14, when the transport motor 20 switches its rotational direction from the second direction to the first direction, both the first winding rotor 16 and the second winding rotor 18 may start rotating after the platen rotor 14 has started rotating. In this case, while being paid out to the first winding core 105, the first ink ribbon 109 may become loose and fail to be properly wound around the first winding core 105, or while being fad to the second winding core 205, the second ink ribbon 209 may become loose and fail to be properly wound around the second winding core 205.

To avoid the above disadvantages, the number of points at which the gears engage with one another between the transport motor 20 and the one-way clutch unit 24 is set to be equal to or smaller than that between the transport motor 20 and the platen rotor 14. The engagement points of the gears between the transport motor 20 and the one-way clutch unit 24 are located between the first motor-side gear 28 and the second motor-side gear 29, between the third motor-side gear 31 and the fourth motor-side gear 32, between the fourth motor-side gear 32 and the first ribbon-side gear 37, and between the second ribbon-side gear 38 and the drive gear 53. The engagement points of the gears between the transport motor 20 and the platen rotor 14 is located between the first motor-side gear 28 and the second motor-side gear 29, between the third motor-side gear 31 and the fourth motor-side gear 32, between the fifth motor-side gear 33 and the first platen-side gear 34, and between the second platen-side gear 35 and the third platen-side gear 36.

In this embodiment, the number of points at which the gears engage with one another between the transport motor 20 and the one-way clutch unit 24 is set to be equal to that between the transport motor 20 and the platen rotor 14. This configuration contributes to a shortened time by which the instant when both the first paying out rotor 15 and the second paying out rotor 17 start rotating is delayed from the instant when the platen rotor 14 starts rotating in the case where the transport motor 20 switches its rotational direction from the first direction to the second direction. Also, the configuration contributes to a shortened time by which the instant when both the first winding rotor 16 and the second winding rotor 18 start rotating is delayed from the instant when the platen rotor 14 starts rotating in the case where the transport motor 20 switches its rotational direction from the second direction to the first direction. However, the number of engagement points of the gears between the transport motor 20 and the one-way clutch unit 24 does not necessarily have to be set to be equal to that between the transport motor 20 and the platen rotor 14. Alternatively, the number of engagement points of the gears between the transport motor 20 and the one-way clutch unit 24 may be set to be smaller than that between the transport motor 20 and the platen rotor 14.

According to a tape printing apparatus 1 in one embodiment, as described above, a paying-out-side one-way clutch 55 is coaxial with a winding-side one-way clutch 56. The tape printing apparatus 1 thereby can switch between modes in which a first winding rotor 16 and a second winding rotor 18 rotate and in which a first paying out rotor 15 and a second paying out rotor 17 rotate without involving the enlargement of a transport gear train 19. In which case, a one-way clutch unit 24 does not occupy a large space.

According to a tape printing apparatus 1 in another embodiment, a clutch mechanism including a paying-out-side one-way clutch 55 and a winding-side one-way clutch 56 provides a decreased time loss caused when the transport motor 20 switches its rotational direction, as opposed to a clutch mechanism in which a second gear rotates and moves around a first gear and engages or is disengaged from a third gear. This configuration thereby contributes to a shortened time by which the instant when a first paying out rotor 15 and a second paying out rotor 17 start rotating is delayed from the instant when a first platen roller 103 or a second platen roller 203 starts rotating in the case where a transport motor 20 switches its rotational direction from a first direction to a second direction. Also, the configuration contributes to a shortened time by which the instant when a first winding rotor 16 and a second winding rotor 18 start rotating is delayed from the instant when the first platen roller 103 or the second platen roller 203 starts rotating in the case where a transport motor 20 switches its rotational direction from the second direction to the first direction.

According to a tape printing apparatus 1 in still another embodiment, a paying-out-side brake section 83 of a brake member 57 reduces generation of a backlash in a first paying-out-side gear 41 at the front end of a paying-out-side one-way clutch 55 in the second direction which is caused by an idle torque of the paying-out-side one-way clutch 55. This configuration contributes to a shortened time by which the instant when a first paying out rotor 15 and a second paying out rotor 17 start rotating is delayed from the instant when a first platen roller 103 or a second platen roller 203 starts rotating in the case where a transport motor 20 switches its rotational direction from a first direction to a second direction. Likewise, a winding-side brake section 84 of the brake member 57 reduces generation of a backlash in a first first-winding-side gear 45 and a first second-winding-side gear 48 at the front end of a winding-side one-way clutch 56 in the first direction. This configuration contributes to a shortened time by which the instant when a first winding rotor 16 and a second winding rotor 18 start rotating is delayed from the instant when the first platen roller 103 or the second platen roller 203 starts rotating in the case where the transport motor 20 switches its rotational direction from the second direction to the first direction.

According to a tape printing apparatus 1 in yet another embodiment, the number of points at which gears engage with one another between a transport motor 20 and a one-way clutch unit 24 is set to be equal to that between the transport motor 20 and a platen rotor 14. This configuration contributes to a shortened time by which the instant when a first paying out rotor 15 and a second paying out rotor 17 start rotating is delayed from the instant when a first platen roller 103 or a second platen roller 203 starts rotating in the case where a transport motor 20 switches its rotational direction from a first direction to a second direction. Also, the configuration contributes to a shortened time by which the instant when a first winding rotor 16 and a second winding rotor 18 start rotating is delayed from the instant when the first platen roller 103 or the second platen roller 203 starts rotating in the case where the transport motor 20 switches its rotational direction from the second direction to the first direction.

### Modifications

The foregoing embodiment may be modified in various ways without departing from the scope of the present disclosure. Some conceivable modifications will be described below.

In the foregoing embodiment, the brake member 57 has the paying-out-side brake section 83 that stops the rotation of the paying-out-side outer ring member 65 by pinching the paying-out-side outer ring projection 68 in a substantially radial direction with the two paying-out-side pinching sections 85. However, the configuration of stopping the rotation of the paying-out-side outer ring member 65 is not limited. Alternatively, the paying-out-side brake section 83 may stop the rotation of the paying-out-side outer ring member 65 by pinching the paying-out-side outer ring member 65 in a thickness direction with the two-side pinching sections 85. Likewise, the winding-side brake section 84 may stop the rotation of the winding-side outer ring member 72 by pinching the winding-side outer ring member 72 in a thickness direction with the two winding-side pinching sections 88. In this case, the brake member 57 may have a common pinching section to pinch the paying-out-side outer ring member 65 and the winding-side outer ring member 72 together in a thickness direction. Alternatively, the brake member 57 may independently pinch the paying-out-side outer ring member 65 and the winding-side outer ring member 72 in a thickness direction. By independently pinching the paying-out-side outer ring member 65 and the winding-side outer ring member 72, it is possible to reduce the risk of one of the paying-out-side outer ring member 65 and the winding-side outer ring member 72 rotating together with the other by means of the sliding friction. In the foregoing embodiment, the paying-out-side brake section 83 and the winding-side brake section 84 are integrated with each other in the brake member 57. However, the configuration of the brake member 57 is not limited. Alternatively, the paying-out-side brake section 83 and the winding-side brake section 84 may be formed separately from each other.

The cartridge mount section 2 of the tape printing apparatus 1 is not necessarily configured to selectively accommodate the tape cartridge 101 and the ribbon cartridge 201. As an alternative example, the cartridge mount section 2 may be configured to accommodate only the tape cartridge 101, in which case the second paying out rotor 17 and the second winding rotor 18 are unnecessary. As another alternative example, the cartridge mount section 2 may be configured to accommodate only the ribbon cartridge 201, in which case the first paying out rotor 15 and the first winding rotor 16 are unnecessary. Moreover, the present disclosure may be applied to ribbon transport mechanisms without the printing head 6.

A description will be given below of supplementary notes of a ribbon transport mechanism and a tape printing apparatus according to some aspects of the present disclosure.

### Supplementary Notes

A description will be given below of supplementary notes of a ribbon transport mechanism and a tape printing apparatus according to some aspects of the present disclosure.

A ribbon transport mechanism provided in a tape printing apparatus includes a paying out rotor and a winding rotor. When a cartridge that includes a paying out core around which an ink ribbon is wound and a winding core that winds the ink ribbon paid out from the paying out core is attached to a cartridge mount section of the tape printing apparatus, the paying out rotor engages with the paying out core and the winding rotor engages with the winding core. The ribbon transport mechanism further includes: a transport motor that generates rotational power; and a transport gear train that receives the rotational power from the transport motor and transmits the received rotational power to both the paying out rotor and the winding rotor. The transport gear train includes a paying-out-side one-way clutch and a winding-side one-way clutch. When the transport motor rotates in a first direction, the paying-out-side one-way clutch suppresses the rotational power received from the transport motor from being transmitted to the paying out rotor, whereas when the transport motor rotates in a second direction, the paying-out-side one-way clutch permits the rotational power received from the transport motor to be transmitted to the paying out rotor; the second direction is opposite to the first direction. When the transport motor rotates in the first direction, the winding-side one-way clutch permits the rotational power received from the transport motor to be transmitted to the winding rotor, whereas when the transport motor rotates in the second direction, the winding-side one-way clutch suppresses the rotational power received from the transport motor from being transmitted to the winding rotor. The paying-out-side one-way clutch is coaxial with the winding-side one-way clutch.

The configuration in which the paying-out-side one-way clutch is coaxial with the winding-side one-way clutch contributes to downsizing of the ribbon transport mechanism.

In the ribbon transport mechanism, the paying-out-side one-way clutch and the winding-side one-way clutch may be identical types of one-way clutches and disposed in mutually opposite orientations.

The above configuration contributes to a decreased number of different types of components.

In the ribbon transport mechanism, the transport gear train may include a drive gear that receives the rotational power from the transport motor and a clutch shaft that rotates together with the drive gear. The paying-out-side one-way clutch may include a paying-out-side inner ring member into which the clutch shaft is fitted and a paying-out-side outer ring member disposed on an outer circumference of the paying-out-side inner ring member. The winding-side one-way clutch may include a winding-side inner ring member into which the clutch shaft is fitted and a winding-side outer ring member disposed on an outer circumference of the winding-side inner ring member.

The above configuration operates the paying-out-side one-way clutch and the winding-side one-way clutch by using a common drive gear and clutch shaft. In short, the paying-out-side one-way clutch and the winding-side one-way clutch share the common drive gear and the clutch shaft, which contributes to a decreased number of components.

In the ribbon transport mechanism, the cartridge may include a platen roller that transports the ink ribbon between the paying out core and the winding core. The ribbon transport mechanism may include a platen rotor that engages with the platen roller when the cartridge is attached to the cartridge mount section. The transport motor may include a paying-out-side brake section that stops the paying-out-side outer ring member from rotating due to an idle torque of the paying-out-side one-way clutch when the transport motor rotates in the first direction.

The above configuration contributes to a shortened time by which the instant when the paying out rotor starts rotating is delayed for the instant when the platen roller starts rotating in the case where the transport motor switches its rotational direction from the first direction to the second direction.

In the ribbon transport mechanism, the cartridge may include a platen roller that transports the ink ribbon between the paying out core and the winding core. The ribbon transport mechanism may include a platen rotor that engages with the platen roller when the cartridge is attached to the cartridge mount section. The transport motor may include a winding-side brake section that stops the winding-side outer ring member from rotating due to an idle torque of the winding-side one-way clutch when the transport motor rotates in the second direction.

The above configuration contributes to a shortened time by which the instant when the winding rotor starts rotating is delayed for the instant when the platen roller starts rotating in the case where the transport motor switches its rotational direction from the second direction to the first direction.

In the ribbon transport mechanism, the cartridge may include a platen roller that transports the ink ribbon between the paying out core and the winding core. The ribbon transport mechanism may include a platen rotor that engages with the platen roller when the cartridge is attached to the cartridge mount section. In the transport gear train, a number of points at which gears engage with one another between the transport motor and the paying-out-side one-way clutch or between the transport motor and the winding-side one-way clutch may be equal to or smaller than a number of points at which gears engage with one another between the transport motor and the platen rotor.

The above configuration contributes to a shortened time by which the instant when the paying out rotor starts rotating is delayed for the instant when the platen roller starts rotating in the case where the transport motor switches its rotational direction from the first direction to the second direction. Also, the configuration contributes to a shortened time by which the instant when the winding rotor starts rotating is delayed for the instant when the platen roller starts rotating in the case where the transport motor switches its rotational direction from the second direction to the first direction.

A tape printing apparatus to which a cartridge that includes a paying out core around which an ink ribbon is wound and a winding core that winds the ink ribbon paid out from the paying out core is to be attached includes: a cartridge mount section to which the cartridge is to be attached; a paying out rotor that, when the cartridge is attached to the cartridge mount section, engages with the paying out core; a winding rotor that, when the cartridge is attached to the cartridge mount section, engages with the winding core; a transport motor that generates rotational power; a transport gear train that receives the rotational power from the transport motor and transmits the received rotational power to both the paying out rotor and the winding rotor; and a printing head that performs a printing operation on a print tape. The transport gear train includes a paying-out-side one-way clutch and a winding-side one-way clutch. When the transport motor rotates in a first direction, the paying-out-side one-way clutch suppresses the rotational power received from the transport motor from being transmitted to the paying out rotor, whereas when the transport motor rotates in a second direction, the paying-out-side one-way clutch permits the rotational power received from the transport motor to be transmitted to the paying out rotor; the second direction is opposite to the first direction. When the transport motor rotates in the first direction, the winding-side one-way clutch permits the rotational power received from the transport motor to be transmitted to the winding rotor, whereas when the transport motor rotates in the second direction, the winding-side one-way clutch suppresses the rotational power received from the transport motor from being transmitted to the winding rotor. The paying-out-side one-way clutch is coaxial with the winding-side one-way clutch.

The configuration in which the paying-out-side one-way clutch is coaxial with the winding-side one-way clutch contributes to downsizing of the tape printing apparatus.

What is claimed is:

1. A ribbon transport mechanism provided in a tape printing apparatus, comprising:
a paying out rotor;
a winding rotor;
when a cartridge that includes a paying out core around which an ink ribbon is wound and a winding core that winds the ink ribbon paid out from the paying out core is attached to a cartridge mount section of the tape printing apparatus, the paying out rotor engaging with the paying out core and the winding rotor engaging with the winding core,
a transport motor that generates rotational power; and
a transport gear train that receives the rotational power from the transport motor and transmits the received rotational power to both the paying out rotor and the winding rotor;
the transport gear train including:
a paying-out-side one-way clutch that, when the transport motor rotates in a first direction, suppresses the rotational power received from the transport motor from being transmitted to the paying out rotor and that, when the transport motor rotates in a second direction, permits the rotational power received from the transport motor to be transmitted to the paying out rotor, the second direction being opposite to the first direction; and
a winding-side one-way clutch that, when the transport motor rotates in the first direction, permits the rotational power received from the transport motor to be transmitted to the winding rotor and that, when the transport motor rotates in the second direction, suppresses the rotational power received from the transport motor from being transmitted to the winding rotor,
the paying-out-side one-way clutch and the winding-side one-way clutch are provided coaxially.

2. The ribbon transport mechanism according to claim 1, wherein
the paying-out-side one-way clutch and the winding-side one-way clutch are identical types of one-way clutches, and
the paying-out-side one-way clutch and the winding-side one-way clutch are disposed in mutually opposite orientations.

3. The ribbon transport mechanism according to claim 1, wherein
the transport gear train includes a drive gear that receives the rotational power from the transport motor and a clutch shaft that rotates together with the drive gear,
the paying-out-side one-way clutch includes a paying-out-side inner ring member into which the clutch shaft is fitted and a −side outer ring member disposed on an outer circumference of the paying-out-side inner ring member, and
the winding-side one-way clutch includes a winding-side inner ring member into which the clutch shaft is fitted and a winding-side outer ring member disposed on an outer circumference of the winding-side inner ring member.

4. The ribbon transport mechanism according to claim 3, wherein
the cartridge includes a platen roller that transports the ink ribbon between the paying out core and the winding core,
the ribbon transport mechanism includes a platen rotor that engages with the platen roller when the cartridge is attached to the cartridge mount section, and
the transport motor includes a paying-out-side brake section that stops the paying-out-side outer ring member from rotating due to an idle torque of the paying out-side one-way clutch when the transport motor rotates in the first direction.

5. The ribbon transport mechanism according to claim 3, wherein
the cartridge includes a platen roller that transports the ink ribbon between the paying out core and the winding core,
the ribbon transport mechanism includes a platen rotor that engages with the platen roller when the cartridge is attached to the cartridge mount section, and
the transport motor includes a winding-side brake section that stops the winding-side outer ring member from rotating due to an idle torque of the winding-side one-way clutch when the transport motor rotates in the second direction.

6. The ribbon transport mechanism according to claim 1, wherein
the cartridge includes a platen roller that transports the ink ribbon between the paying out core and the winding core,
the ribbon transport mechanism includes a platen rotor that engages with the platen roller when the cartridge is attached to the cartridge mount section, and
in the transport gear train, a number of points at which gears engage with one another between the transport motor and the paying-out-side one-way clutch or between the transport motor and the winding-side one-way clutch is equal to or smaller than a number of points at which gears engage with one another between the transport motor and the platen rotor.

7. A tape printing apparatus to which a cartridge is to be attached, the cartridge including a paying out core around which an ink ribbon is wound and a winding core that winds the ink ribbon paid from the paying out core, the tape printing apparatus comprising:
a cartridge mount section to which the cartridge is to be attached;
a paying out rotor that, when the cartridge is attached to the cartridge mount section, engages with the paying out core;
a winding rotor that, when the cartridge is attached to the cartridge mount section, engages with the winding core;
a transport motor that generates rotational power;
a transport gear train that receives the rotational power from the transport motor and transmits the received rotational power to both the paying out rotor and the winding rotor; and
a printing head that performs a printing operation on a print tape,
the transport gear train including:
a paying-out-side one-way clutch that, when the transport motor rotates in a first direction, suppresses the rotational power received from the transport motor from being transmitted to the paying out rotor and that, when the transport motor rotates in a second direction, permits the rotational power received from the transport motor to be transmitted to the paying out rotor, the second direction being opposite to the first direction; and
a winding-side one-way clutch that, when the transport motor rotates in the first direction, permits the rotational power received from the transport motor to be transmitted to the winding rotor and that, when the transport motor rotates in the second direction, suppresses the rotational power received from the transport motor from being transmitted to the winding rotor,
the paying-out-side one-way clutch being coaxial with the winding-side one-way clutch.
